(19) United States
(12) Patent Application Publication
(10) Pub. No.: US 2009/0125394 A1
(43) Pub. Date: May 14, 2009

(54) Wireless communications device as in-store assistant

(76) Inventors: Jonathan Otto, Palm Beach, FL (US); Michael R. Mueller, San Francisco, CA (US); Andrew Van Luchene, Santa Fe, NM (US)

Correspondence Address: SIMPSON & SIMPSON, PLLC, 5555 MAIN STREET, WILLIAMSVILLE, NY, 14221-5406, US

(21) Appl. No.: 11/985,268

(22) Filed: Nov. 14, 2007

(51) Int. Cl. H04Q 5/22; G06Q 30/00

(52) U.S. Cl. 705/14; 340/10.1

(57) ABSTRACT

A method for using a wireless communications device, including the steps of: determining, using an interface element and a processor in at least one specially programmed general-purpose computer, that at least one wireless communications device (WCD) is located in a retail location; generating, using the processor, a query; outputting, using the processor and the interface element, the query for transmission to the at least one WCD; receiving, using the interface element, a reply to the query transmitted from the at least one WCD; generating, using the processor, a message responsive to the reply; and outputting, using the processor and the interface element, the message for transmission to the at least one WCD. In one embodiment, the reply is regarding locating an item and the message includes a location for the item.

### CROSS-REFERENCE TO RELATED APPLICATIONS

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to methods and systems for communicating with a wireless communications device. In particular, the invention relates to communication between a wireless communications device and a system for a retail location.

### BACKGROUND OF THE INVENTION

Currently, retail sales locations can offer an extremely wide variety of choices to consumers. For example, Wal-Mart, the world's largest retailer, offers literally thousands of items to its customers at any one location. This variety and volume of items provides consumers with a wide number of options, while tending to drive prices lower and lower. Buying and selling at such high volumes has obvious benefits for the retailer as well. However, a major drawback to such variety is the increasing difficulty of consumers in finding the products they are looking for. Unfortunately, many customers, even regular customers, are frustrated by the difficulty in located desired items in the location. A common reason for customers not finding such item(s) is large size of the store, the large number of items offered in the store, and the paucity of employees to assist customers in finding items.

Thus, there is a long-felt need to provide a system and method for providing a means of assisting customers in finding items in a retail location using devices readily available to the customer or already in possession of the customer.

### SUMMARY OF THE INVENTION

The present invention broadly comprises a method for using a wireless communications device, including the steps of: determining, using an interface element and a processor in at least one specially programmed general-purpose computer, that at least one wireless communications device (WCD) is located in a retail location; generating, using the processor, a query; outputting, using the processor and the interface element, the query for transmission to the at least one WCD; receiving, using the interface element, a reply to the query transmitted from the at least one WCD; generating, using the processor, a message responsive to the reply; and outputting, using the processor and the interface element, the message for transmission to the at least one WCD.

In one embodiment, the at least one WCD includes a graphical user interface (GUI) and the query includes instructions to configure the GUI. In one embodiment, the reply is regarding locating an item and the message includes a location for the item. In one embodiment, the item includes a radio frequency identification (RFID) tag and the method includes, locating, using the interface element and the processor, the RFID tag and wherein the message includes the RFID location.

In one embodiment, the method includes: identifying, using the processor, a additional item; generating, using the processor, an offer regarding the additional item; and outputting, using the processor and the interface element, the offer for transmission to the at least one WCD. In one embodiment, the message includes a path from a location of the WCD to the location for the item. In one embodiment, the at least one WCD includes a plurality of WCDs and: outputting, using the interface element, the query for transmission to the at least one WCD includes outputting the query to the plurality of WCDs; and outputting the message for transmission to the at least one WCD includes outputting the message for transmission to the plurality of WCDs.

In one embodiment, the reply is regarding contacting personnel in the retail location and the method includes, using the interface element and the processor, linking the at least one WCD with the personnel. In one embodiment, the reply is regarding contacting personnel in the retail location and the message includes information regarding a location for the personnel. In one embodiment, the reply is regarding acquiring information regarding a condition in the retail location and the message includes information regarding the condition. In one embodiment, the method includes receiving, via the interface element, an on-line request regarding an item in the retail location and the message includes information regarding a location for the item. In one embodiment, the method includes compiling, using the processor, a history of purchases by an entity associated with the at least one WCD and generating a message includes generating a message based on the history. In one embodiment, the method includes tracking, using the interface element and the processor, at least one item in the retail location and in apparent possession of an entity associated with the at least one WCD and generating a message includes generating a message including an offer based on the at least one item.

The present invention also broadly comprises a system for using a wireless communications device.

It is a general object of the present invention to provide a method and system for a wireless communications device in a retail location to communicate with a system for the retail location.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a present invention system for using a wireless communications device; and,

FIG. 2 is a flow chart depicting a present invention method for using a wireless communications device.

### DETAILED DESCRIPTION OF THE PREFERRED EMBODIMENT

At the outset, it should be appreciated that like drawing numbers on different drawing views identify identical, or functionally similar, structural elements of the invention.

While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

The following non-limiting definitions are applicable to the present invention:

Business—includes any business enterprise formed for the purpose of providing a product or service, which may or may not be for profit.

Business objective—includes any desired outcome of a business or business owner, including, for example, acquisition of new customers, delivery of one or more marketing offers, increases or improvements in product quality or service, sales, profits, customer counts, customer visitation frequency, customer loyalty, average check, average item counts, order contents, speed of service measurements, labor rates, sales per labor hour, year over year or same store sales, percentage market share, annual or periodic growth rates, employee or management retention or turnover rate, inventory control or turns, inventory waste, raw or finished waste, increases in stock prices, improved return on assets or equity, or any other objective as determined by management or other authorized individual or as established by rules or other metrics including or stored in a system designed for such purposes.

Business Information—includes any information that is provided, known, gathered, assumed or is otherwise determined or stored that is related to or is about or otherwise helps understand, define, operate, improve, track or report the performance of, a business, for example, customer acquisition and sales data, marketing information, click-through rates, conversion rates, profit and loss information, accounting information, financial information, statistics and ratios, customer information, sponsor information, information about any one or more business, customer or sponsor objectives, or any other information, business metrics and data gathered or stored or otherwise possessed or accessible by a business and/or any of its affiliates, sponsors, customers or investors.

Controller—means any one or more of the following electronic devices including, but not limited to: cell phones, Personal Digital Assistants or (PDA's), Blackberry or similar devices, such as hand held computers, MP3 players, or any other personal electronic device that has one or more of a keyboard, speaker, microphone, one or more buttons, or any other similar devices that provides a User with Input and/or Output Functionality and Remote Connectivity. A Controller may be or include one or more of a Display and/or a Server or other computing devices or means of computing.

Coupon—includes an offer presented in the form of an electronic or printed ticket or document which may include a discount or rebate when purchasing one or more products from a business or sponsor. In certain embodiments, a coupon may include a bar code, RFID, or other means of identification, which may include information that can verify any one or more of the type of coupon, valid offer dates, customer, business or sponsor information, discount amounts, restrictions, permissions, items required to purchase to receive a discount or rebate, and/or items to which a discount or rebate applies, location information, including where the coupon is valid, e.g., which store or stores, or website, and/or any other information that might assist or be of benefit to the issuer or recipient or the processor, e.g., a cashier, and/or the processing system, e.g., a POS terminal or POS system, and/or a sponsor or other business entity, and/or any information that might encourage distribution, delivery, redemption or use of any such coupon or that might improve the results of any coupon or coupon marketing campaign, e.g., a viral marketing campaign or new product introduction.

Customer Facing Display—includes any device accessible by an end user or customer that includes at least one of a display, input means, e.g., a touch screen or keyboard, or other output means, e.g., a speaker. In certain embodiments, a Customer Facing Display may include a Kiosk, POS Terminal, or other computing device, such as a cell phone, PDA, laptop or PC. In certain embodiments a customer facing display may be a POS or POS terminal and vice versa.

Customer Identifier—includes, but is not limited to a cell phone, an RFID tag, a credit card, a debit card, a frequent shopper card or number, a coupon, a license plate, a check, a loyalty or gift card, fingerprint or other biometric input, a driver's license, or other identification means.

Customer Information—includes any information that is provided, known, gathered, assumed or is otherwise determined or stored that is related to or is about or otherwise helps understand or define a customer and/or a customer's buying habits, preferences or tendencies. Such information may include the customer's (or any related person, e.g., a child) order history, order contents, ideal order acceptance or rejection data, willingness to accept or reject one or more marketing offers or messages (either specific or types or categories of offers), price point or price elasticity, tendency to attempt to game other otherwise attempt to take advantage of the system or marketing program, average order total, e.g., average check, average item count, e.g., average number of items in a given order, average customer count, e.g., how many persons in the party on average, any demographic information, e.g., income, race, mailing address, zip codes, phone numbers, household total income, number of children, age, sex, number and type of internet enabled devices, participation in one or more marketing programs, willingness to use kiosks, cell phones or other ordering devices, prior ordering history, including willingness or tendency to accept pre, mid and/or post order marketing offers, e.g., suggestive selling, cross selling, sponsor rewards, or any other offers, and/or any other information gathered or provided by/from the customer, e.g., preferences information gathered by observing such customer behavior, e.g., does customer switch from cold beverages to hot beverages in the wintertime, and/or information gathered or supplied by a marketing program and/or by such customer when signing up or otherwise maintaining such information in a customer loyalty or other marketing program's database, or by importing or otherwise accessing information about such customer via any public or commercially accessible database and/or any combination of the foregoing information.

Customer Objective—includes any desired outcome, behavior that benefits a customer, including, for example, improved or better pricing, service, e.g., friendly service, speed of service, accuracy of service, quality of delivered products, types of marketing offers and/or savings associated with each, cleanliness of location, type of online or other ordering systems, including, e.g., POS devices, or any other favorable treatment or benefit that can be obtain or otherwise accrues to the benefit of such customer, and/or any combination of the foregoing.

Dilution—includes any outcome that has a net negative effect, e.g., an acceptance of an upsell or other offer results in providing a discount on an item, which a customer might otherwise have paid full price.

Discount—includes any price or offer at an amount other than the standard list price or expected price or shelf price, or displayed price, e.g., online.

Display—includes any one or more of the following electronic devices including, but not limited to: TV (of any technology type, including but not limited to a Plasma Display, LCD, CRT or DLP), Kiosk, LED display, Electronic Shelf Label, Automated Teller Machine (ATM), POS terminal, video game display, video slot machine or other video based casino games, speaker, or any other device capable of displaying, presenting or otherwise outputting or processing Output Materials (such as an LCD or other display in an airline seatback or other Location, e.g., a grocery cart equipped with a display and/or a bar code or RFID printer or reader), including devices that provide a User with Output Functionality. A Display may include or be one or more of a Controller and/or a Server and/or other computing device capable of providing Input and/or Output Functionality and/or Remote Connectivity.

Domain Name Server (DNS)—One or more computers including a cooperatively run set of databases, distributed among several servers, volunteered as repositories for IP address information.

End User—includes any person or entity making use of any one or more of the methods of the disclosed invention, and/or any system that uses or is based upon or benefits from one or more of the disclosed inventions, including, for example, customers, vendors, retailers, QSR operators, managers, employees, supervisors, friends, family members, or any other person as applicable to the given context or otherwise.

Existing Member—includes a member of a loyalty program or other marketing program and/or a person that has signed up for any marketing or other program and/or has provided information to such a program, whether or not such person is aware of such program, including, end users.

Frequent Shopper Program—includes any system that provides one or more rewards to members of such program for purchases made.

Frequency Program—includes any Frequent Shopper Program or other rewards system that rewards customers for their frequency of visit and/or buying one or more products, goods or services.

GUI—includes a graphical user interface, or other means of providing communications from or to an end user, including via graphics, text, audio, video, data input, such as voice, typing, touch screen, or other means of input or output to/from any device, including a POS Terminal, or other computing devices. Such GUI may include information and/or actions that are available for viewing, use or interaction with an end user. Such interaction may be accomplished via any applicable means, including, for example, manipulating icons, widgets or other items or areas displayed on such GUI, including, clicking on one or more hyperlinks, and/or entering information into fields or other areas designed for such purposes, e.g., typing a name, or selecting one or more items from a displayed list, etc.

Header—A numeric code assigned to a request for content by either a LAN or ISP Server, which identifies a requestor's unique Internet Protocol Address. Generally, the Header is used for purposes of accurately returning a requested Mark-up Language-based electronic document as well as any corresponding files to the requestor.

Hyperlink—A text phrase or graphic embedded within a markup language-based electronic file, which corresponds to the address of a site on the World Wide Web.

Input Functionality—includes any one or more of any of the following, including but is not limited to any device that includes or provides one or more buttons (e.g., a keyboard) that can convey individual or grouped electrical signals, impulses, commands, or messages, or other tactile or other input device including a joy stick, mouse, touch screen, and/or audio (e.g., voice commands or instructions), bar code scanner, RFID reader, fingerprint or other biometric scanning device, scale, laser pointer, camera, infrared sensor, cell phone, hand held computer or PDA keypad, motion or other “presence” detector, magnetic card or magnetic card reader, and any other input method recognizable by or able to convey information to any one or more of a Display, Server, Controller or other computing device.

Internet—includes the world wide web and the network that is accessible by the public that includes a network of interconnected computers that transmit data using, for example, Internet Protocol (IP). In some aspects, certain private networks, including virtual private networks (VPN) may be included in the definition of the Internet.

Internet Device or Internet Enabled Device—includes any computing device that is capable of accessing or otherwise communicating with or via the Internet or any other network, client/server and/or peer-to-peer or any other network, and/or that is otherwise able to practice or benefit from any one or more of the herein disclosed inventions.

Internet Ordering or Online Purchase—includes the processing, in whole or in part, of any one or more transactions using or otherwise communicating via the Internet or other means of communications by or between any one or more of a business, sponsor and/or one or more customers, which transaction may be for or include the purchase, trade or acquisition of one or more items. In certain embodiments, internet ordering or online purchases may include the delivery of one or more marketing messages or marketing offers.

Item—includes any object, tangible or intangible, which may include any item for sale, rental, lease, consumption, transfer, and/or may be possessed or owned. Item may include any physical or virtual object. In certain embodiments an item may be any one or more of a food item, a beverage item, a dessert item, a retail good, a food product, a device, a POS device, a coupon, clothing, furnishings, groceries, automobiles, motorcycles, lighting, electrical equipment or devices, etc.

Kiosk—includes any device or location that permits a customer or end user to enter part or all of an order and/or respond to a marketing message or offer, with or without the assistance of a third party, e.g., a cashier. Kiosks may include software to prevent end users from performing unauthorized actions and/or accessing the system, operating system or other secure areas of the kiosk and/or systems to which it may be attached or connected, e.g., the Internet or one or more servers, etc.

Location—means and includes, but is not limited to retail stores, restaurants, bars, theme parks, casinos, video game parlors, Internet Café's, coffee bars, book stores, gas stations, convenience stores, hotel rooms, hotel or other lobbies, meeting rooms, office buildings, offices, airports, airplanes, government or other public services buildings, hospitals or any other public or private area or facility or residence that contains, possesses or otherwise provides limited or general access to at least one Display and/or practices part or all of any one or more embodiments of the present invention.

Loyalty or Frequent Shopper Member—includes any end user or person that has joined or signed up or opted into a loyalty program and/or frequent shopper program.

Loyalty Member—a person that has signed up for or otherwise participates in a loyalty or frequent shopper program.

Loyalty Program—any system that permits users to sign up to receive rewards based upon such user's purchases or visitation frequency.

Marketing Message—Includes a marketing offer, or any other communication with an end user, e.g., a customer, which message may include any one or more of the following such as, any one or more of a graphic, logo, icon, price, discount or other offer, video, audio, or other visual, audio or static marketing or other content designed to communicate with or otherwise inform, educate or persuade a User. In certain embodiments, a marketing message may include one or more marketing offers.

Marketing Offer or Offer—includes any offer for sale of any item, good, product or service.

Marketing Program—includes any system that provides marketing messages, marketing content, loyalty programs, coupons, discounts, or any other offers or marketing offers, and/or tracks customer buying habits and other information, including customer information, such as locations, travels, demographics, ordering preferences, etc.

Markup Language—A set of codes in a text file that instructs a computer how to format the file for purposes of printing and/or display, as well as how to index and link the content of the file. Example markup languages include HTML, SGML, XML, VRML, and NRML.

Network Device—includes any device that can be interfaced with a technology network, for example, the Internet, a wireless communications network, (e.g., a cellular telephone system), a LAN, or a WAN.

Optimized—includes determining which marketing offer will likely or generally achieve the desired results or maximum results among or given one or more of several complimentary or competing objectives, including, for example, sales volume, gross margin, profits, customer accept rates, average check, speed of service times, product quality, freshness, customer satisfaction, customer frequency, order point, destination point or any other variables that affect or are of interest to one or more affected parties, e.g., the retail establishment, its suppliers and/or the customer. In certain embodiments, optimized includes finding the maxima or minima of a given function. In certain embodiments, the terms optimized and optimal have corollary meanings.

Output functionality—includes transmission of information via Remote Connectivity and/or conveying Output Materials on a Display and/or tactile feedback.

Output Materials means any one or more of the following, including but is not limited to any one or more of, Marketing Messages, audio, still images and/or video, flash and/or other animated sequences or materials, printed or visual reports or receipts, displayed information, information recorded to or stored on a hard drive or other computer readable medium, a text message, voice mail message, a sound such as a beep or bell or buzzer, audio messages (e.g. a voice prompt or marketing message or other information), including recorded, actual or synthetic voice messages, or any other output generated by a Display, Server, Controller, Network or other device or application that is sent to or processed by a User, Display, Server, Controller, Network or other device for subsequent viewing, listening and/or further processing or storage.

PC—includes a personal computer, such as a laptop, such as one provided by Dell Computers.

PDA—includes a personal digital assistant, such as Palm Pilot, or any other personal computing device, which includes at least one of a display, processor, memory or input or output means.

Point of Sale—includes any Point of Sale system or device that permits an end user to start, enter or complete an order or sales transaction, such as Panasonic's 7900 “all in one”, or any other POS devices, terminals or systems, websites, kiosks, PCs, PDAs, Cell Phones, call centers, slot machines, vending machines, and/or any other Internet or other device that provides access to any of the functionality or inventions disclosed herein and or any of the same or similar functionality and/or otherwise permits an end user to practice or benefit from any of the disclosed inventions. Point of Sale and POS shall have corollary meanings.

POS Device, includes a POS or other physical device that provides access to any of the features or inventions disclosed herein and or any of the same or similar functionality and/or otherwise permits an end user to practice or benefit from any of the disclosed inventions.

POS Terminal—includes a POS or other physical device that provides access to any of the foregoing and or any of the same or similar functionality and/or otherwise permits an end user to practice or benefit from any of the disclosed inventions.

Product—includes any machine, manufacture and/or composition of matter, unless expressly specified otherwise.

Prospective Member—includes any person that is not currently a member.

Referral—includes any prospective member identified or otherwise provided by an existing member.

Proximal, Proximity, Proximal/Proximity Data—includes any information about an end user's current or predicted whereabouts. Such information may include distance, i.e., distance between two points, e.g., a retail location and the end user, which distance may be measured directly, e.g., point A to point B, or based upon travel means, e.g., based upon the streets or other paths that a person or end user could actually use to travel from said point A to said point B, and/or may be based upon time, e.g., how long it might take a given end user to travel said distance between point A and point B, perhaps further as determined by such end user's current rate of travel or average rate of travel or method of travel, etc. Methods to calculate distances between to points in space and/or to estimate travel time are well known by those of ordinary skill in the art.

Referral Coupon—includes a marketing message, marketing offer, or other offer, including, for example, a coupon provided to an existing member for providing the identity or other information of a prospective member and/or an action taken by such prospective member, including, for example, such prospective member becoming a member and/or accepting a similar or other marketing offer, e.g., by redeeming a coupon.

Response—includes any action and/or failure to act by any person. For example, a response from a prospective member includes the immediate or subsequent reply to or use of one or more marketing messages or offers or other response, which response includes, but is not limited to, for example, signing up to one or more loyalty, frequency or other marketing programs, acceptance and/or use, e.g., redemption, of any one or more offers or coupon, opting in to one or more loyalty, frequency or other marketing program(s), achieving or maintaining a certain level of sales and/or number or frequency of store visits, purchases of certain products, providing one or more email addresses, visiting one or more retail, restaurant or other store location(s), ordering one or more items, or specific items, or failure to order one or more items or specific items, filling out a form or forms, or providing additional information, such as mailing address, phone number, internet device id information, and/or signing up for one or more third party sponsor programs, and/or any other action as determined or established by the marketing program, pressing one or more buttons and/or clicking on one or more hyperlinks or any combination of the foregoing. The terms response and respond shall have corollary meanings. In some embodiments a referral coupon may be a reward and/or a reward may be a referral coupon. In certain embodiments a referral coupon may be a viral coupon and vice versa.

Reports—in certain of the disclosed embodiments, one or more reports may be developed to provide tracking and/or analysis relating to any one or more data elements associated with any such embodiment or invention. Reports include any feedback or communication requested by or delivered to one or more end users, which may or may not require authorization to receive such report. Reports can be printed, verbalized using a text to speech conversion program, or displayed on any device, including, for example, a POS terminal or other computing device. Such reports may be created and/or delivered using any applicable means available. The methods to create and deliver reports are well understood and known within the industry and are disclosed in the prior art. Reports may be demand request, i.e., a report is generated only when or as requested, or exception based, i.e., a report is generated if a certain condition or conditions are met, not met or change in any defined way. In certain embodiments, reports are generated whenever desired or otherwise indicated or scheduled, and may be stored for subsequent use, which use may or may not be based on a request by an end user. Reports may include any one or more available database elements and/or calculated results based upon any one or more of the databases, database elements, mathematical or statistical manipulations, and/or any of the methods disclosed herein and/or as understood by any person skilled in the art and/or as requested/designed by one or more end users or other authorized personnel. For example, a report may include any one or more pieces of information contained or relating to customer, business or sponsor information, and/or POS transaction data and/or any or all results information generated or associated with any marketing offer or message.

Reward—includes any item or object or incentive that is or might be of benefit to its recipient, for example, a free or discounted item or a financial incentive, presented to an end user, e.g., an existing loyalty or marketing program member. In certain embodiments, rewards may be provided without any action of or by the recipient to receive such reward. In other embodiments, recipients must perform certain actions, e.g., purchase items from a business, or make a commitment to make such purchases, in order to receive, earn or otherwise qualify for any such reward(s). In some embodiments, a reward may be cash or an offer of cash or other financial currency or benefit. In certain embodiments, a reward may be an item, such as a toy, or a coupon. In yet other embodiments, a reward may be a combination of any or all of the foregoing. In certain embodiments, rewards may be created, funded or otherwise provided by businesses or sponsors. Rewards may be offered and/or delivered using any applicable means, including electronic transmission via the Internet, cell phones, text or voice mail, and may include one or more marketing messages or marketing offers. Rewards may be issued, granted or provided by individuals or groups and/or delivered or provided to individuals or groups. In certain embodiments, recipients of one or more rewards may be required to perform a certain task or tasks to qualify and/or to make use of one or more rewards. In some embodiments, rewards may be used only by the specific individual(s) who received the reward. In addition or in the alternate, rewards may be transferable or do not specify the recipient or require that only the recipient may benefit from such reward(s). In some embodiments a coupon may be a reward and/or a reward may be a coupon.

Viral Reward—includes any reward, coupon or other incentive designed to encourage additional use of such reward and/or to encourage one or more additional persons to join a loyalty or marketing program and/or to help achieve any other business, sponsor or customer objective(s). In some embodiments, viral rewards may be communicated via any applicable means, including, for example, via email, voice mail or text based messaging services. The terms viral reward, network reward, viral coupon, and network coupon shall have corollary meanings.

RFID—includes a radio frequency identification tag, transponder or similar devices.

Router—An intermediary device within a communications network that expedites message delivery. Within a single network linking many computers through several possible connections, a router receives transmitted messages and forwards them to their correct destination via an efficient available route.

Sensor—includes any application or device that can make a determination or otherwise detecting the change, presence or absence of something, including, for example, temperature, weight, sound, pressure, volume, mass, light, odors, and/or any recording, or registration, change, presence or absence of or to any data or other electronic media. In certain embodiments a sensor includes one or more transducers.

Sponsor—includes any third party or entity that provides product, goods or services and/or money or other financial means to an end user or retail entity in exchange for the option to communicate with such end user, including, for example, to provide one or more marketing messages or offers, including, e.g., a cross sell offer or sponsor reward.

Store—includes any one or more retail, restaurant or other location, and may include online locations, websites, kiosks, automated stores, e.g., vending machines, so called “brick and mortar” locations, and/or any combination of the foregoing, and/or access to any such location(s) using any POS device.

Sponsor information—includes any information that is provided, known, gathered, assumed or is otherwise determined or stored that is related to or is about or otherwise helps understand, define, operate, improve, track or report the performance of, a sponsor business, for example, customer acquisition and sales data, marketing information, click-through rates, conversion rates, profit and loss information, accounting information, financial information, statistics and ratios, customer information, sponsor information, information about any one or more sponsor objectives, or any other information, business metrics and data and/or business information gathered or stored or otherwise possessed or accessible by a sponsor and/or any of its affiliates, businesses, customers or investors.

Sponsor objective—includes any desired outcome of a sponsor or sponsor business owner, including, for example, acquisition of new customers, conversion of competitor's customers to sponsor's customers, delivery of one or more marketing messages or offers, increases or improvements in sales, profits, customer counts, customer visitation frequency, customer loyalty, average check, average item counts, order contents, speed of service measurements, labor rates, sales per labor hour, year over year or same store sales, percentage market share, annual or periodic growth rates, employee or management retention or turnover rate, inventory control or turns, inventory waste, raw or finished waste, increases in stock prices, improved return on assets or equity, or any other objective as determined by management or other authorized individual or as established by rules or other metrics including or stored in a system designed for such purposes.

Subscription—includes an agreement, which may be implicit or explicit, to purchase a certain quantity of goods, services, products or items and/or purchase the rights to use or access such goods, services, products or items, during or over a specified period of time, and/or an agreement to spend a certain amount of money over a certain period. In certain embodiments, subscriptions may be accepted through an action or failure to act by a subscriber or end user. In certain embodiments, subscriptions may automatically renew based upon an action or inaction of a subscriber or end user. In certain embodiments, a virtual subscription may be accomplished without formal agreement among the affected parties, e.g., by selling a razor that requires use of specific blades.

Tag—A code embedded within an markup language-based electronic file which associates one or more words or images within the document with a Uniform Resource Locator (URL) corresponding to another file. Within the art, a tag of this particular functionality may be referred to as an “HREF” (hypertext reference) tag.

Transaction—includes any communication or agreement between two or more entities, including end users, individuals, retailers, and/or computing systems. In certain embodiments a transaction can include a financial transaction wherein a seller sells and item and a buy buys an item, where such seller may experience an increase in finances while the buyer's finances may decrease. In certain embodiments, a transaction may include a communication between a computing system and an one or more end users, or between two computing systems, a computing system and a database or data repository, two end users, two or more data repositories, etc. In additional embodiments, a transaction includes a POS transaction, where a customer places and pays for one or more items, goods, services, or products and/or access to or use of any or all of the foregoing, and/or via a website and/or using a POS terminal or POS device.

Trial Coupon—includes any offer that encourages the purchase of a new item or an item an end user has not yet tried, which offer may be presented using any applicable means, including use of an electronic or printed coupon.

Upsell—includes any offer to purchase one or more items at a full, discounted or other price including the retail price. Upsells include offers to increase an order size, quantity, type or contents of an entity's, e.g., a customer's order.

Upsell/Instruction/Commission Output device—includes, but is not limited to: a POS terminal, a website, a drive through or other digital menu board, a drive through speaker, a cell phone, telephone, pager or PDA, a kiosk, a vending machine, a customer counter display, an in-store or other digital menu board, a display built into a restaurant table, a vending machine, a speaker, or slot machine.

User—includes any entity or person including a person making use or practicing the various disclosed embodiments of the invention. The terms user and end user shall include corollary meanings.

User-Visible Text Portion—A portion of markup language-based code which specifies the text or other images to be displayed to a Web user. An example (in bold) as well as the corresponding tag (underlined) follows: Ex. <A HREF=“http://go.msn.com/npl/msnt.asp” target=“_top”><IMG SRC=“/chan/home/logo.gif” WIDTH=140 HEIGHT=60 BORDER=0 ALT=“Go to msn.com”>Microsoft Network</A>

Web Browser—A client application that enables a user to view markup language-based documents on the World Wide Web, another network, or the user's computer; utilize the hyperlinks among the documents, as well as transfer and execute files within the documents.

Web Site—A subset of the World Wide Web comprising a collection of files, documents and graphics made generally available to others through the Internet. In certain embodiments a web site may include means for conducting a transaction, including, for example, a POS transaction.

Wireless Communications Device (WCD)—A communications device that transceives via a non-wired medium, such as radio frequency. A WCD can include, but is not limited to an AM or FM radio device, a television, cell phones, portable phones, and devices, such as laptop computers and PDAs interfaced with a wireless network, for example, a LAN. Applicable formats, standards or protocols, include Ethernet (or IEEE 802.3), SAP, ATP, Bluetooth, and TCP/IP, TDMA, CDMA, and 3G.

World Wide Web—The total set of inter-linked hypertext documents residing on Hypertext

Computing. It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. A “processor” means one or more microprocessors, central processing units (CPUs), computing devices, microcontrollers, digital signal processors, or like devices or any combination thereof.

A description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software or hardware only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

Remote Connectivity means any method used by a Controller, a Display or a Server or other computing devices to communicate with other devices or networks including, but not limited to the Internet, Satellite networks, Cell Phone networks, other wireless networks and standards such as 802.11, 80211.b, 802.11g, or similar wireless LAN operating standards, or Bluetooth technologies, infrared connections, or any other similar technologies or other technologies such as those described above that permit the sending and/or receiving and/or processing of electronic information in either an encrypted or unencrypted format.

Server means one or more computing systems that include at least one of a processor, computer readable medium, or input/output capabilities and may have local or Remote Connectivity capabilities. Servers may be local or remote to Displays or both. A Server may be or include one or more of a Display and/or a Controller.

In an embodiment, a Server computer or centralized authority may not be necessary or desirable. For example, the present invention may, in an embodiment, be practiced on one or more devices without a central authority. In such an embodiment, any functions described herein as performed by the Server computer or data described as stored on the Server computer may instead be performed by or stored on one or more such devices.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

“Determining” something can be performed in a variety of manners and therefore the term “determining” (and like terms) includes calculating, computing, deriving, looking up (e.g., in a table, database or data structure), ascertaining, recognizing, and the like. A “display” as that term is used herein is an area that conveys information to a viewer. The information may be dynamic, in which case, an LCD, LED, CRT, LDP, rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as standard definition (SDTV), enhanced definition (EDTV), high definition (HD), or the like. The information may likewise be static, in which case, painted glass may be used to form the display. Note that static information may be presented on a display capable of displaying dynamic information if desired.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices. Exemplary processors are the INTEL PENTIUM or AMD ATHLON processors. The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, TDMA, CDMA, GSM, EDGE, GPRS, WCDMA, AMPS, D-AMPS, IEEE 802.11 (WI-FI), IEEE 802.3, SAP, SAS™ by IGT, OASIS™ by Aristocrat Technologies, SDS by Bally Gaming and Systems, ATP, TCP/IP, gaming device standard (GDS) published by the Gaming Standards Association of Fremont Calif., the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The present disclosure provides, to one of ordinary skill in the art, an enabling description of several embodiments and/or inventions. Some of these embodiments and/or inventions may not be claimed in the present disclosure, but may nevertheless be claimed in one or more continuing applications that claim the benefit of priority of the present disclosure.

It will, of course, be understood that the foregoing description is of exemplary embodiments of the invention and that the invention is not limited to the specific embodiments shown. Various changes and modifications will become apparent to those skilled in the art and all such variations and modifications are intended to come within the spirit and scope of the appended claims.

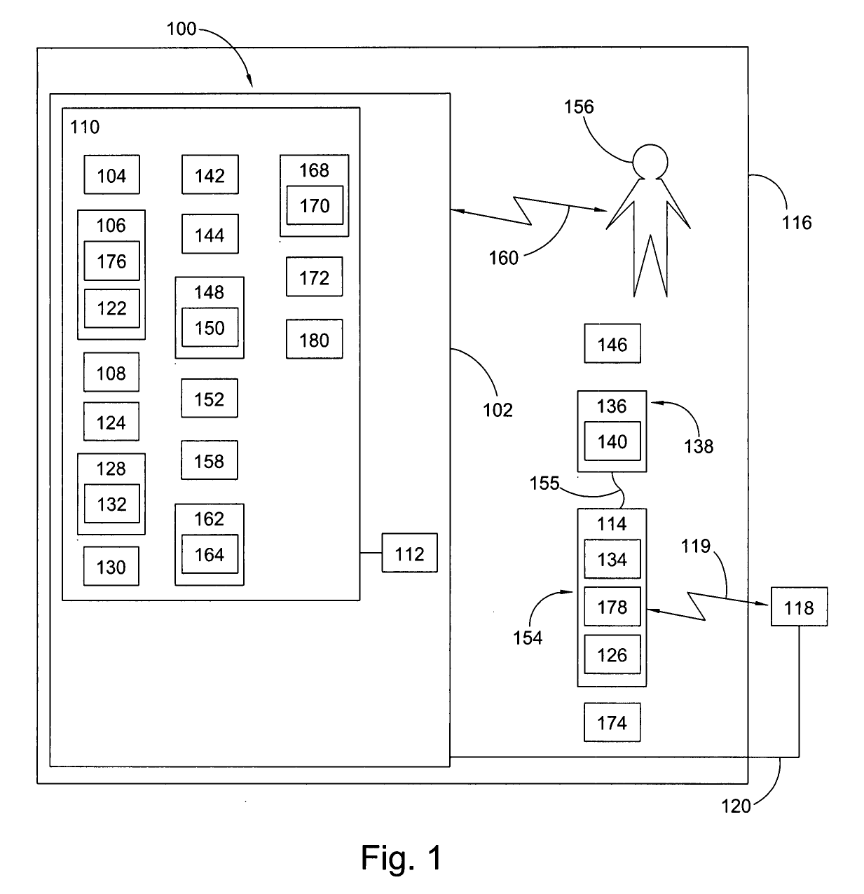

FIG. 1 is a schematic diagram of present invention system 100 for using a wireless communications device. System 100 includes specially programmed general-purpose computer 102 with determining element 104, generating element 106, and outputting element 108 in processor 110. Alternately stated, elements 104, 106, and 108 and any other elements described as being in the processor are functions of the processor or are junctions carried out by the processor. Element 104 is arranged to determine, using interface element 112 in the general-purpose computer and any means known in the art, that at least one wireless communications device (WCD) 114 is located in retail location 116 or within a specified distance of the location. Computer 102 is associated with retail location 116. By retail location, we mean a location where goods are offered for sale and may be kept on hand for dispersal or subsequent shipment or delivery to customers. Goods can be offered by any pricing structure known in the art, for example, goods can be offered at manufacturer's list prices available to the general public or can be offered at wholesale prices only available to prospective customers meeting certain requirements. It should be understood that system 100 is not limited to use with a single, physical location. For example, the retail location can be associated with a plurality of other retail locations, e.g., the retail location is part of a chain of stores, and system 100 can be in place at any or all of the locations.

By interface element, we mean any combination of hardware, firmware, or software in a computer used to enable communication or data transfer between the computer and a device, system, or network external to the computer. Computer 102 can be any computer or combination of computers known in the art. Processor 110 and interface element 112 can be any processor or interface element, respectively, or combination thereof, known in the art.

A WCD is defined supra. WCD 114 can be any WCD known in the art. In one embodiment, a person entering location 116 is provided with WCD 114, for example, by an entity operating the location. In one embodiment, WCD 114 is owned by, leased by, or otherwise already in possession of the end user when the end user enters the retail location. In the description that follows, it is assumed that the WCD is owned by, leased by, or otherwise already in possession of the end user when the end user enters the retail location. In general, the WCD communicates with a network, for example, network 118, via radio-frequency connection 119. Network 118 can be any network known in the art. In one embodiment, the network is located outside of the retail location, for example, the network is a commercial cellular telephone network. In one embodiment (not shown), the network is located in the retail location, for example, the network is a local network, such as a Bluetooth network. The interface element can connect with network 118 using any means known in the art, including, but not limited to a hardwire connection, an optical connection, an Internet connection, or a radio frequency connection. In the figures, a non-limiting example of a hardwire connection 120 is shown. In one embodiment, device 114 is connectable to a docking station (not shown), for example, a docking station on a shopping cart, to enable device 114 to establish communication with system 100. Any docking station or docking means known in the art can be used. That is, when the device is connected to the docking station, a link is established between the device and system 100. The docking station is interfaced with element 112 via a wireless connection.

In response to locating device 114, generating element 106 generates query 122. In general, the query is related to an action that a user of the WCD may wish to engage in, addresses a potential concern or question the user of the WCD may have, requests information from the user, or offers help to the user of the WCD. However, it should be understood that the query is not limited to any particular type of activity or content. Outputting element 108 outputs, using the interface element, query 122 for transmission to the at least one WCD, for example, via network 118. In general, query 122 is configured to elicit a response from the user of the WCD.

System 100 also includes receiving element 124 in the processor arranged to receive, using the interface element, reply, or response, 126 to the query. The response is transmitted from the WCD, for example, through network 118. The configuration, format, and information contained in the response depend upon the configuration and format of the query as further described infra. System 100 includes generating element 128 and outputting element 130 in the processor. Element 128 is arranged to generate message 132 including response to reply 126. The contents of the message are described infra. Element 130 is arranged to output, using the interface element, the message for transmission to the WCD. In one embodiment (not shown), elements 106 and 128 are the same element. In one embodiment (not shown) elements 108 and 130 are the same element.

In one embodiment, the WCD includes graphical user interface (GUI) 134 and the query includes instructions to configure the GUI as further described infra. For example, the instructions may configure the GUI to display a special screen with menus, prompts, etc. specifically designed and implemented to enable communication between processor 102 and the WCD. For example, keys on the WCD could be reconfigured to enable communication with the processor. The reconfiguring may be automatically implemented by the WCD or may require action by the user of the WCD. For example, when an end user (with WCD 114) enters retail location 116, element 104, in some cases using network 118, determines that WCD 114 is within the location and establishes communications with the WCD. Such connection may be made by any means known in the art, including, but not limited to, sending a text message that enables the end user to more easily establish a link with system 100. For example, such text message might simply enable the end user to touch one key on the WCD to establish a link, or such message might provide the end user with a menu of choices, e.g., press 1 to view or search all items, 2 for hardware, 3 for music, 4 for children's toys, etc.

In one embodiment, the reply is regarding locating item 136, for example, in location 116, and message 132 includes location 138 for the item as further described infra. For example, the query may ask if the location of an item is desired and in response to a positive reply, the processor, for example, generator 128, determines a location for the item and provides the location in message 132. It should be understood that other intermediate steps may be involved. For example, one or further corresponding queries and responses may be generated and transmitted to narrow down or further define the information desired. In one embodiment, item 136 includes radio frequency identification (RFID) tag 140 and locating element 142 in the processor is arranged to locate, using the interface element and/or any other means known in art, the RFID tag. Then, message 132 includes the RFID location, for example, location 138. In one embodiment, the item is identified as described in commonly owned United States patent application titled “COMBINED VIRTUAL AND PHYSICAL SHOPPING CART,” inventors Otto et al., filed Nov. 9, 2007, which application is incorporated herein by reference.

In one embodiment, system 100 includes identifying element 144 in the processor arranged to identify additional item 146. In one embodiment, item 146 is in location 116. In one embodiment (not shown), the additional item is not located in location 116, for example, the additional item may be in a different retail location or may be available through an on-line ordering arrangement (not shown). Generating element 148 in the processor is arranged to generate offer 150 regarding the additional item. Then, outputting element 152 in the processor is arranged to output, using the interface element, the offer for transmission to the WCD. In one embodiment (not shown), elements 106 and 148 are the same element. In one embodiment (not shown) elements 108 and 152 are the same element. As described infra, item 146 can be identified by, for example, the location of the WCD, an item in apparent possession of the user of the WCD, or a buying history of the user.

In one embodiment, element 104 determines location 154 for the WCD, element 128 determines path 155 from the WCD to item 136 as further described infra. For example, element 128 includes a map of location 116 in message 132 and GUI 134 displays the map with the path shown. However, it should be understood that any means known in the art can be used to provide and display path 154.

In one embodiment, the reply is regarding contacting personnel, for example, employee 156, in the retail location and linking element 158 in the processor is arranged to link, using the interface element, the WCD with the personnel. Any means known in the art can be used to implement the link. In one embodiment, personnel 156 are linked to the interface element via wireless link 160, for example, linking to a cell phone or two-way radio device carried by the personnel. The reply regarding contacting personnel can include a request type, for example, locate item, ask an expert, what type of item, or what type of expert. Then, element 158 determines appropriate store personnel to contact. Element 158 can determine the location of the personnel in the location, can send the location to the WCD via the interface element, and can advise the personnel that a user of the WCD is looking for the personnel. In one embodiment, element 158 determines location 154, sends location 154 to the personnel, and arranges for a message to be sent, for example, via elements 128 and 130, to the WCD advising that personnel are on the way. In one embodiment, link element 158 enables direct communication between the WCD and the personnel, for example, via link 160.

In one embodiment, linking element 158 accounts for personnel being busy with another incoming call when element 158 attempts to contact the personnel. In this case, the linking element queues the replies from the WCD as the replies are received. In one embodiment, the queued replies are presented to the store personnel in the order that the replies are received. In one embodiment, element 158 determines a time estimate for personnel to responds to a queued reply and generates a notification, including the time estimate, for transmission to the WCD.

In one embodiment, personnel 156 are given bonuses based on the number of replies regarding contacting personnel that the personnel respond to, for example, the number of replies filled in a given time period. In one embodiment, the WCD receives preferential treatment, for example, replies from the WCD are moved to the top of a queue. The preferential treatment can be obtained, for example: by having the end user of the WCD pay a fee; based on a history of the end user (further described infra), such as the number of transactions by the end user with the retail location or the revenue for the retail location associated with the end user; or membership in a loyalty program.

In one embodiment, system 100 includes receiving element 162 in the processor arranged to receive, via the interface element, on-line request 164 regarding an item (not shown). In one embodiment, element 128 includes information regarding the item in message 132, for example, if the item is in stock in location 116 and if so, information regarding a location for the item. In one embodiment, the message is then communicated via the on-line connection to an off-site (with respect to location 116) source (not shown). In one embodiment, the on-line message is correlated to the WCD and when the WCD is identified by element 104, the information regarding the item is sent to the WCD.

In one embodiment, prior to entering location 116, an end user can search for items online and send a shopping list (not shown) to WCD 114. In the process of detecting the WCD, element 104 determines that the WCD is storing a shopping list and accesses the shopping list. For example, query 122 can include instructions to transmit the list to the receiving element, which relays the list to element 128, or the list can be included in reply 126. In one embodiment, an end user can search for items online and send a shopping list as request 164 to system 100. In the process of detecting the WCD, element 104 determines that element 164 has a shopping list and element 128 accesses the shopping list.

In one embodiment, element 128 generates a store map based on the shopping list noted above. In one embodiment, to generate the map, element 128 determines the respective locations in the retail location for the items on the list and then highlights the respective locations on the map. In one embodiment, location 154 of the WCD also is used to form the map. In one embodiment, items on the list are clustered by location on the map. As items are procured by the end user, the items are deleted from the map display. In one embodiment, the procured item is identified as described in commonly owned United States patent application titled “COMBINED VIRTUAL AND PHYSICAL SHOPPING CART,” inventors Otto et al., filed Nov. 9, 2007, which application is incorporated herein by reference. The route may be the most optimal in terms of time or distance or may be selected to cause the end user to pass by other items, for example, items that may be related to current or past purchases. For example, if a history for the end user (described infra) shows that the end user has not purchased a certain item within a specified period of time, the path noted above can be modified to pass by a display of the certain item and/or message 132 can include a suggestive offer for the item. In one embodiment, the route or offer is generated as described in commonly owned United States patent application titled “Method and System for Generating, Selecting, and Running Executables in a Business System Utilizing a Combination of User Defined Rules and Artificial Intelligence,” inventors Otto et al., filed Nov. 9, 2007, which application is incorporated herein by reference.

In one embodiment, a shopping list is generated to list items for a recipe. For example, the on-line communication noted above includes a recipe, element 128 identifies the components of the recipe and then creates a store map regarding the components as noted above.

In one embodiment, while shopping online or while communicating with system 100 in location 116, an end user of WCD 114 receives other marketing messages, marketing offers, upsells, or other coupon offers or recommendations. For example, if a customer has found a CD via system 100, the system can recommend another CD or an ancillary item, such as a disk cleaner, to the end user. Such a suggestion or recommendation may or may not include a discount. For example, the suggested additional CD may be a full priced recommendation, while the CD cleaner, which might be overstocked, may be offered at a discount or free if the end user agrees to purchase the original and/or suggested CD. In one embodiment, the offer is generated as described in commonly owned United States patent application titled “Method and System for Generating, Selecting, and Running Executables in a Business System Utilizing a Combination of User Defined Rules and Artificial Intelligence,” inventors Otto et al., filed Nov. 9, 2007, which application is incorporated herein by reference.

In one embodiment, system 100 includes memory element 168 in the processor arranged to store history 170 of purchases by an entity associated with the WCD. In one embodiment, the history is compiled as described in commonly owned United States patent application titled “Method and System for Generating, Selecting, and Running Executables in a Business System Utilizing a Combination of User Defined Rules and Artificial Intelligence,” inventors Otto et al., filed Nov. 9, 2007, which application is incorporated herein by reference. Then, generating element 128 is arranged to generate message 132 based on the history. For example, element 128 may note trends, patterns, or preferences associated with past purchases made by the entity (as shown in the history) and may customize the message to align with the trends, patterns, or preferences. For example, the message could provide an offer or information regarding a product or products purchased by the entity in the past. In one embodiment, the offer is generated as described in commonly owned United States patent application titled “Method and System for Generating, Selecting, and Running Executables in a Business System Utilizing a Combination of User Defined Rules and Artificial Intelligence,” inventors Otto et al., filed Nov. 9, 2007, which application is incorporated herein by reference.

In one embodiment, system 100 includes tracking element 172 in the processor arranged to track, using the interface element, at least one item 174 in apparent possession of the WCD. In one embodiment, element 172 determines apparent possession by determining that item 174 is in the immediate area of the WCD, for example, closer than items in shelves or displays near the WCD, and/or that the item is moving with the WCD, indicating item 174 is being held by an entity using the WCD or is in a shopping cart or basket etc., or the user has informed system 100 that the user has the item. In one embodiment, item 174 is identified as described in commonly owned United States patent application titled “COMBINED VIRTUAL AND PHYSICAL SHOPPING CART,” inventors Otto et al., filed Nov. 9, 2007, which application is incorporated herein by reference. Then, element 128 includes, in the message, an offer based on the at least one item. For example, the offer could be regarding another product that could be used with item 174 or an upsell to another product similar to item 174. In one embodiment, the offer is generated as described in commonly owned United States patent application titled “Method and System for Generating, Selecting, and Running Executables in a Business System Utilizing a Combination of User Defined Rules and Artificial Intelligence,” inventors Otto et al., filed Nov. 9, 2007, which application is incorporated herein by reference.

In one embodiment, element 128 generates message 132 at least partially in response to location 154 and/or item 174. Thus, a retailer is better able to anticipate the needs of their customers. For example, message 132 includes an offer or information regarding products within a specified distance of location 154. In one embodiment, the offer or information is generated as described in commonly owned United States patent application titled “Method and System for Generating, Selecting, and Running Executables in a Business System Utilizing a Combination of User Defined Rules and Artificial Intelligence,” inventors Otto et al., filed Nov. 9, 2007, which application is incorporated herein by reference. As another example, if a customer is in the music section of a department store, and such customer has already placed three CDs with jazz titles into their shopping cart, the system might make an offer for an additional jazz title that is similar to or otherwise recommended with respect to the three CDs. When accepting such an offer, the end user might receive the offer along with more specific item location information, e.g., where to find the offered item(s).

It is possible that more than one WCD (not shown) may be associated with the owner of WCD 114. These multiple WCDs may be in the possession of one person, for example, the person in possession of WCD 114 or may be in the possession of one or more other persons in addition to the person in possession of WCD 114. In one embodiment, element 104 is arranged to identify those WCDs from among the multiple WCDs that enter the retail location, generating element 108 is arranged to output the query for transmission to the WCDs that entered, the receiving element is arranged to receive replies 126 from one or more of the WCDs that entered, and outputting element 130 is arranged to output message 132 for transmission to the respective WCDs. In one embodiment, the respective locations of the multiple WCDs are determined by element 104 and respective messages 132, each geared to the respective locations of the WCDs, are generated by element 128. For example, the respective messages 132 include respective offers or information regarding respective products within a respective specified distances of the respective locations of the WCDs. In one embodiment, the offers are generated as described in commonly owned United States patent application titled “Method and System for Generating, Selecting, and Running Executables in a Business System Utilizing a Combination of User Defined Rules and Artificial Intelligence,” inventors Otto et al., filed Nov. 9, 2007, which application is incorporated herein by reference.

In one embodiment, system 100 communicates information, for example, respective location information, among the multiple WCDs. For example, a family might visit location 116 and various members of the family go to separate parts of the location. If, for example, the family has agreed to permit the sharing of information, perhaps with an entity operating location 116 or with network 118, system 100 provides the various family members with respective location information for the other family members at any given moment. Such information may be displayed via any applicable means, including, for example, by department or by showing a store layout with icons representing the respective WCD for each family member. In one embodiment, system 100 determines the location of employees, for example, employee 156 and provides the information to the WCD or WCDs. In one embodiment, a knowledgeable employee is located, based on history 170, item 174, location 154, or in response to a request in reply 126.

In one embodiment, system 100, for example, element 106, generates a follow-up query 176, following the transmission of message 132, for transmission to the WCD. The follow-up query is to determine if message 132 met the needs of the end user of the WCD, for example, if the end user was able to find item 136. The receiving element then is enabled to receive reply 178 from the WCD in response to message 176. In one embodiment, if the end user was not able to find the item and this information is included in reply 178, a flag is set on the reply and transmitted to store personnel. In response to the flag, personnel take appropriate action, such as check inventory for the item. In one embodiment, the linking element links the WCD and store personnel so that the personnel can assist the end user via wireless connection 160 or so that the personnel can meet the end user. In one embodiment, the receiving element generates a report regarding messages 176 and replies 178 for use by the retail location.

In one embodiment, for an out of stock item, the WCD can be used as described in commonly owned United States patent application titled “WIRELESS COMMUNICATIONS DEVICE CONFIGURED TO ORDER OUT OF STOCK ITEMS,” inventors Otto et al., filed Nov. 9, 2007, which application is incorporated herein by reference.

In one embodiment, system 100 provides other location information to WCD 114. For example, the system provides information about which check-out line or lines (not shown) are open and/or are moving more quickly so that the end user can seek out the best line. Information regarding check-out lines can be obtained by any means known in the art, for example, sensors (not shown) that detect the number of persons in a line or monitoring respective point of sales devices for the lines to determine if the devices are in operation. Such additional information may be affected by current or prior knowledge of the customer's buying habits, for example, history 170, whether the end user is using credit or cash, or the number of items the end user is purchasing. The information noted above can be provided continuously, periodically, or only upon demand.

Thus, system 100 provides end users with a method to use their WCD, for example, a cell phone, PDA, or personal electronic device, to find items within a given location, for example, location 116. For example, if an end user of, or entity using, WCD 114 is looking for a CD, such end user may not know what category of music to search under or basic information regarding the CD. Instead of browsing all the CD's or asking a sales representative, who may not be available or knowledgeable enough for a given task, the end user can search for the CD using the WCD.

In one embodiment, to aid the end user in searching a large database, the menu noted above is organized in categories with one or more subcategories under each major category. In one embodiment, a search tool is provided that accesses only those items available in the location. For example, a search engine vendor provides a search engine that provides an end user of WCD 114 with search access to the inventory database for location 116. If the end user has already selected a major category or sub-category, the search engine can restrict the search to the major category or sub-category, and/or may sort any search results and weigh more heavily those items that are in such search results set(s) based upon such major category or sub-category. In this fashion, end users, i.e., consumers, find what they are searching for more easily and search results are generally more accurate or useful without necessarily eliminating from a search the actual item they are seeking, which may be associated with a different major or sub-category than the major or sub-category such end user expects the item to be associated. In one embodiment, system 100 provides access to another location (not shown) and/or to a website inventory (not shown) associated with a business entity, for example, the business entity operating location 116.

In one embodiment, by combining item location information with location 154, system 100 can direct end users to items that are in stock but are misplaced. For example, a particular CD, although in stock is in a location other than the original/expected location for the CD. Even though such CD is in stock, an end user of WCD 114 may be unable to find the misplaced CD. However, system 100 can locate the CD and the WCD and provide information to the WCD regarding the location of the CD, in particular, with respect to the location of the WCD. In one embodiment, such location information is provided to an employee in location 116 who can then replace the misplaced item to its proper locations.

In one embodiment, locating element 180 uses information from end users, for example, replies 126 and 178, shopping lists, and/or locations 138 and 154 to determine or modify locations for items in location 116. For example, histories 170 for a plurality of customers of the retail location can include the respective replies and locations noted above and can be assessed. For example, the analysis of the replies and locations may show that multiple requests for the location of an item were made from a certain part of the retail location (the item is not in the certain part). Based on this history, element 180 determines that the item should be located near the certain part or in the certain part. As another example, if multiple shopping lists include two or more of the same items, element 180 determines that the two or more items should be located close together. In one embodiment, the analysis is performed as described in commonly owned United States patent application titled “Method and System for Generating, Selecting, and Running Executables in a Business System Utilizing a Combination of User Defined Rules and Artificial Intelligence,” inventors Otto et al., filed Nov. 9, 2007, which application is incorporated herein by reference.

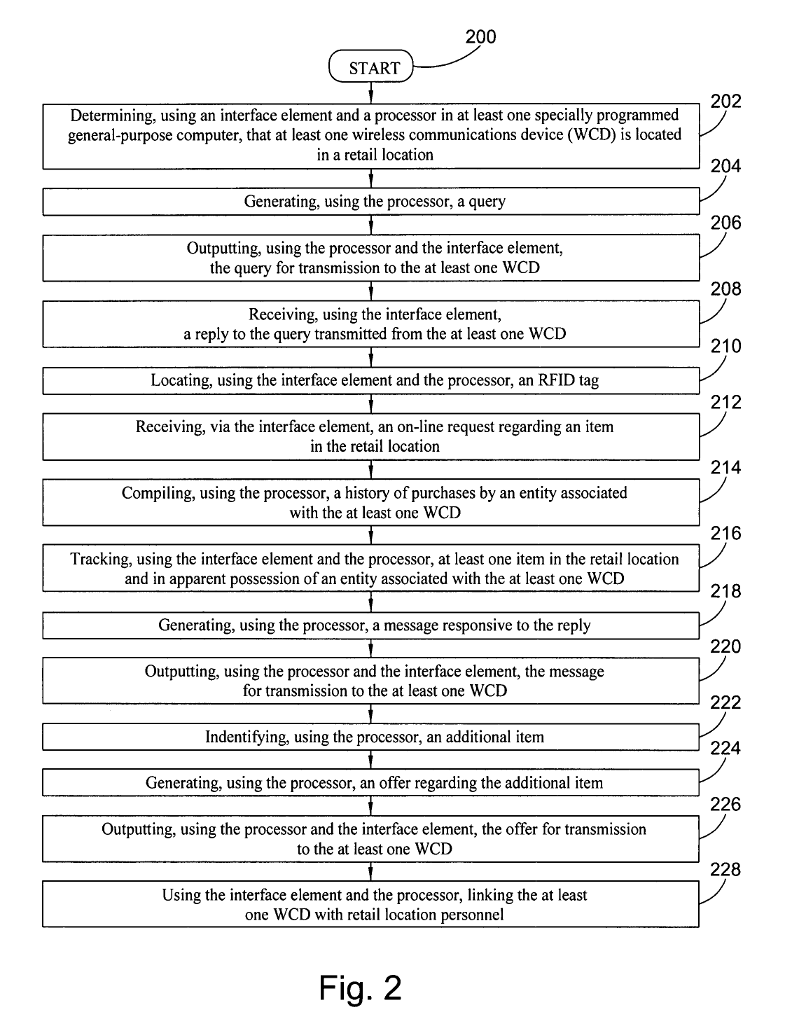

FIG. 2 is a flow chart illustrating a present invention method for using a wireless communications device. Although the method in FIG. 2 is depicted as a sequence of numbered steps for clarity, no order should be inferred from the numbering unless explicitly stated. The method starts at Step 200. Step 202 determines, using an interface element and a processor in at least one specially programmed general-purpose computer, that at least one wireless communications device (WCD) is located in a retail location. Step 204 generates, using the processor, a query, for example, regarding an activity in the retail location. Step 206 outputs, using the processor and the interface element, the query for transmission to the at least one WCD. Step 208 receives, using the interface element, a reply to the query transmitted from the at least one WCD. Step 218 generates, using the processor, a message responsive to the reply. Step 220 outputs, using the processor and the interface element, the message for transmission to the at least one WCD.

In one embodiment, the at least one WCD includes a graphical user interface (GUI) and the query includes instructions to configure the GUI. In one embodiment, the reply is regarding locating an item and the message includes a location for the item. In one embodiment, the item includes an RFID tag and Step 210 locates, using the interface element and the processor, the RFID tag and the message includes the RFID location.

In one embodiment, Step 222 identifies, using the processor, an additional item. Step 224 generates, using the processor, an offer regarding the additional item. Step 226 outputs, using the processor and the interface element, the offer for transmission to the at least one WCD.

In one embodiment, the message includes a path from a location of the WCD to the location for the item. In one embodiment, the at least one WCD includes a plurality of WCDs and step 204 includes outputting the query to the plurality of WCDs and step 220 includes outputting the message for transmission to the plurality of WCDs.

In one embodiment, the reply is regarding contacting personnel in the retail location and step 228, using the interface element and the processor, links the at least one WCD with the personnel. In one embodiment, the reply is regarding contacting personnel in the retail location and the message includes information regarding a location for the personnel. In one embodiment, the reply is regarding acquiring information regarding a condition in the retail location and the message includes information regarding the condition.

In one embodiment, step 212 receives, via the interface element, an on-line request regarding an item in the retail location and the message includes information regarding a location for item. In one embodiment, step 214 compiles, using the processor, a history of purchases by an entity associated with the at least one WCD and step 218 includes generating a message based on the history. In one embodiment, step 216 tracks, using the interface element and the processor, at least one item in the retail location and in apparent possession of an entity associated with the at least one WCD and step 218 includes generating a message including an offer based on the at least one item.

The following is a listing of exemplary data bases that can be used in a present invention method or system. It should be understood that a present invention method or system is not limited to any or all of the databases shown and that other databases are included in the spirit and scope of the claimed invention.

End User Database: Device ID 1-n; Device Info 1-n; Personal Info; Historical Transaction Info; Item Locater requests 1-n.

Item database: Item ID: Location 1-n; Qty; Cost; and Price.

Survey Database: Survey ID and Survey Content.

Transaction Database: ID; Items 1-n; Customers; Item Locater Requests; Store Personnel requests; Shopping List ID; and Recipe ID 1-n.

Recipe database: ID; Descriptor; Item ID 1-n; and Recipe instructions.

Shopping List database: End User ID; Item ID 1-n; Map; Item Purchased Y/N; Map Used Y/N; Date Created; and Date Used.

Store Personnel Request Database: Request ID; Customer ID; Personnel ID; Request Made Date and time; and Request Answered Data and time.

Store Personnel Request Database: Request ID 1-n; Date/Time requested; and Position in queue 1-n.

Store Layout Database: Store Diagram and Inventory ID 1-n.

Item location request database: Request ID; Item ID; Customer ID; Request Date and Time; Pick up date and Time; Purchase date and Time; Survey; and Survey response.

Not Found Item Database (use the survey to see if item was found or not, also if item is not available just add it to this database): Item ID; Locater Request ID; and Date/Time.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A method for using a wireless communications device, comprising the steps of:
determining, using an interface element and a processor in at least one specially programmed general-purpose computer, that at least one wireless communications device (WCD) is located in a retail location;
generating, using the processor, a query;
outputting, using the processor and the interface element, the query for transmission to the at least one WCD;
receiving, using the interface element, a reply to the query transmitted from the at least one WCD;
generating, using the processor, a message responsive to the reply; and,
outputting, using the processor and the interface element, the message for transmission to the at least one WCD.

2. The method of claim 1, wherein the at least one WCD further comprises a graphical user interface (GUI) and the query further comprises instructions to configure the GUI.

3. The method of claim 1 wherein the reply is regarding locating an item and wherein the message includes a location for the item.

4. The method of claim 3 wherein the item comprises a radio frequency identification (RFID) tag and the method further comprising, locating, using the interface element and the processor, the RFID tag and wherein the message includes the RFID location.

5. The method of claim 3 further comprising:
identifying, using the processor, a additional item;
generating, using the processor, an offer regarding the additional item; and,
outputting, using the processor and the interface element, the offer for transmission to the at least one WCD.

6. The method of claim 3 wherein the message includes a path from a location of the WCD to the location for the item.

7. The method of claim 1 wherein the at least one WCD further comprises a plurality of WCDs and wherein:
outputting, using the interface element, the query for transmission to the at least one WCD includes outputting the query to the plurality of WCDs; and,
outputting the message for transmission to the at least one WCD includes outputting the message for transmission to the plurality of WCDs.

8. The method of claim 1 wherein the reply is regarding contacting personnel in the retail location and the method further comprising, using the interface element and the processor, linking the at least one WCD with the personnel.

9. The method of claim 1 wherein the reply is regarding contacting personnel in the retail location and wherein the message includes information regarding a location for the personnel.

10. The method of claim 1 wherein the reply is regarding acquiring information regarding a condition in the retail location and wherein the message includes information regarding the condition.

11. The method of claim 1 further comprising receiving, via the interface element, an on-line request regarding an item in the retail location and wherein the message includes information regarding a location for the item.

12. The method of claim 1 further comprising compiling, using the processor, a history of purchases by an entity associated with the at least one WCD; and wherein generating a message includes generating a message based on the history.

13. The method of claim 1 further comprising tracking, using the interface element and the processor, at least one item in the retail location and in apparent possession of an entity associated with the at least one WCD; and wherein generating a message includes generating a message including an offer based on the at least one item.

14. A system for using a wireless communications device, comprising:
a determining element a processor in at least one specially programmed general-purpose computer arranged to determine, using an interface element in the general-purpose computer, that at least one wireless communications device (WCD) is located in a retail location;
a first generating element in the processor arranged to generate a query;
a first outputting element in the processor arranged to output, using the interface element, the query for transmission to the at least one WCD;
a first receiving element in the processor arranged to receive, using the interface element, a reply to the query transmitted from the at least one WCD;
a second generating element in the processor arranged to generate a message responsive to the reply; and,
a second outputting element in the processor arranged to output, using the interface element, the message for transmission to the at least one WCD.

15. The system of claim 14 wherein the at least one WCD further comprises a graphical user interface (GUI) and the query further comprises instructions to configure the GUI.

16. The system of claim 14 wherein the reply is regarding locating an item and wherein the message includes a location for the item.

17. The system of claim 16 wherein the item comprises a radio frequency identification (RFID) tag and the system includes a locating element in the processor arranged to locate, using the interface element, the RFID tag and wherein the message includes the RFID location.

18. The system of claim 16 further comprising:
an identifying element in the processor arranged to identify an additional item;
a third generating element in the processor arranged to generate an offer regarding the additional item; and,
a third outputting element in the processor arranged to output, using the interface element, the offer for transmission to the at least one WCD.

19. The system of claim 16 wherein the message includes a path from a location of the WCD to the location for the item.

20. The system of claim 14 wherein the at least one WCD further comprises a plurality of WCDs and wherein:
the first outputting element is arranged to output the query for transmission to the plurality of WCDs; and,
the second outputting element is arranged to output the message for transmission to the plurality of WCDs.

21. The system of claim 14 wherein the reply is regarding contacting personnel in the retail location and the system includes a linking element in the processor arranged to link, using the interface element, the at least one WCD with the personnel.

22. The system of claim 14 wherein the reply is regarding contacting personnel in the retail location and wherein the message includes information regarding a location for the personnel.

23. The system of claim 14 further comprising a second receiving element in the processor arranged to receive, via the interface element, an on-line request regarding an item in the retail location and wherein the message includes information regarding a location for item.

24. The system of claim 14 further comprising a compiling element in the processor, arranged to compile a history of purchases by an entity associated with the at least one WCD; and wherein the second generating element is arranged to generate the message based on the history.

25. The system of claim 14 further comprising a tracking element in the processor arranged to track, using the interface element, at least one item in apparent possession of an entity associated with the WCD; and wherein the message includes an offer based on the at least one item.
